(19) United States
(12) Patent Application Publication
(10) Pub. No.: US 2006/0266273 A1
(43) Pub. Date: Nov. 30, 2006

(54) System and method of modular vehicle gauge system and illumination

(76) Inventors: Todd Westberg, Cherry Valley, IL (US); Doug Calvert, Hudson, WI (US); James Verdouw, Rockford, IL (US); Bob Toms, Rapid City, SD (US)

Correspondence Address: DICKSTEIN SHAPIRO LLP, 1825 EYE STREET NW, Washington, DC, 20006-5403, US

(21) Appl. No.: 11/374,070

(22) Filed: Mar. 14, 2006

Related U.S. Application Data
(60) Provisional application No. 60/661,020, filed on Mar. 14, 2005.

(51) Int. Cl. B60Q 1/34; G01P 5/00

(52) U.S. Cl. 116/62.1; 116/35 R

(57) ABSTRACT

A modular vehicle gauge system includes a remote unit, a sensor module and at least one gauge. The remote unit includes a first microcontroller, a memory and an interface to allow communications with the sensor module and the at least one gauge. The sensor module includes a second microcontroller, and an interface to allow communications with the remote unit and the at least one gauge. The at least one gauge includes a third microcontroller, an interface to allow communications with the remote unit, and means for changing an illumination of the at least one gauge upon the occurrence of an event. The modular vehicle gauge system also includes means for exchanging information between the remote unit, the sensor module and the at least one gauge.

### PRIORITY

This application claims the benefit of U.S. Provisional Patent Application No. 60/661,020 filed on Mar. 14, 2005, the entire disclosure of which is incorporated herein by reference.

### BACKGROUND OF THE INVENTION

There is a need for a modular vehicle gauge system, which allows an operator to select, implement and interchange vehicle gauges of interest without a complete re-wiring of the system and without having to use extraneous or unwanted gauges. There is a need to allow the operator to personalize the system by selecting the gauges to be included in the vehicle gauge system and to associate the gauges with certain illumination colors.

There is a need for a “Red Alert” gauge warning, which grabs the attention of the vehicle operator, via a sudden change in gauge illumination, when a warning condition for a gauge arises. It is desirable for the warning to be displayed using red illumination, but in instances where the operator has the gauges set to red illumination for normal operation, the warning should change illumination of the gauges to a non-red color (such as e.g., blue).

### SUMMARY OF THE INVENTION

The invention provides a full time, operator selectable, multiple (e.g., seven) color LED gauge illumination in a vehicle gauge system. An operator may choose from, e.g., blue, white, red, orange, green, yellow, or purple lighting for the gauges in the system. The operator may change the illumination color whenever he wants at the touch of a button through a user interface.

The invention provides a dynamic color sequencing light display of its gauges, which includes a continuous lighting spectrum shift through, e.g., seven illumination colors for show and demonstration operational modes of the system.

The invention provides performance driving simulation demonstration gauge operations to simulate performance driving readings.

The invention provides a full dial “Red Alert” warning. In an aspect of the invention, an attention-grabbing full dial, red illumination warning alerts the driver of critical conditions for individual readings as they arise. Warning points are operator programmable via a remote interface for application-specific accuracy. Importantly, if the gauges are normally operating with red illumination, their illumination will shift to another color (e.g., blue) when a warning condition arises.

The invention provides remote operation of various system aspects. An illuminated remote operator interface provides for programming warning points, gauge illumination color selection and dimming, demonstration operational modes, peak readings review, and record and playback operational modes. The remote operator interface may comprise a secure digital (SD) memory card expansion slot for housing a secure digital memory (or other digital memory or memory interface).

The invention provides for memory card expansion to allow for extended recording of sensor and gauge responses. The memory can allow operator programmable initialization, shutdown, and demonstration sequences. Web upgradeable programming may also be supported.

The invention uses a novel N1.0™ network technology to connect the system gauges to a sensor module. Modular cable connections ease installation and network expansion.

The invention provides engine speed (RPM) channel capability to record engine RPM data for playback or PC download. The invention can also interface to a race-proven tachometer.

The invention provides peak reading recall and run recording memory which allows an operator to access continuously updated peak data readings for each gauge of the system via the remote operator interface. The invention allows continuous data from all gauges connected to the system network to be recorded for a period of time (e.g., 35 seconds) for playback and review with internal recording memory.

The invention provides gauges with microprocessor controlled 270 degree sweep stepper movements. Rugged, self-calibrating, stepper motor pointer movements provide reliable, precision readings. Air core motors may also be used with the invention. Electric sensors, mounted in the engine compartment, keep hazardous fluids out of passenger compartment for driver and occupant safety. The 270° dial sweep provides easy readings and “at a glance” accuracy.

The foregoing and other advantages and features of the invention will become more apparent from the detailed description of exemplary embodiments provided below with reference to the accompanying drawings.

### DESCRIPTION OF THE DRAWINGS

FIG. 1 illustrates a first exemplary embodiment of a system of the invention.

FIG. 2 illustrates a second exemplary embodiment of a system of the invention.

FIG. 3 illustrates a technique for mounting a sensor module of the system in a vehicle.

FIG. 4 illustrates a first exemplary wiring for the sensor module of the system.

FIG. 5 illustrates an additional exemplary wiring for the sensor module of the system.

FIG. 6 illustrates the sensor module and its ports and switches in detail.

FIG. 7 illustrates an exemplary wiring of gauges to the sensor module in accordance with the invention.

FIGS. 8 and 9 illustrate an exemplary remote unit.

FIGS. 10 and 11 illustrate gauges in accordance with the invention.

FIG. 12 illustrates a third exemplary embodiment of a system of the invention.

FIG. 13 is a flow chart for displaying sensor information on selected gauges.

FIG. 14 shows a flow chart for adjusting the illumination of selected LEDs based on the occurrence of a warning condition.

### DESCRIPTION OF PREFERRED EMBODIMENTS

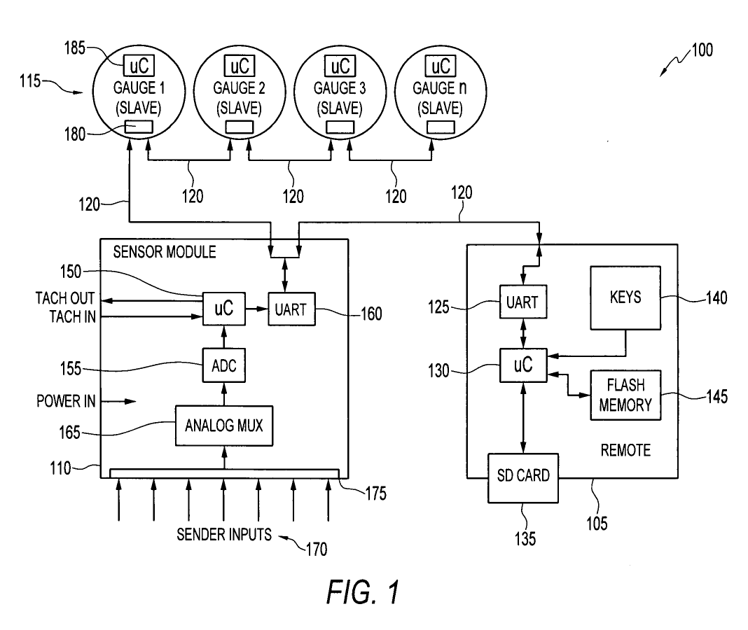

FIG. 1 illustrates one system configuration of the invention (i.e., system 100). The FIG. 1 configuration includes a remote unit 105 located inside the vehicle, a sensor module 110 located in the vehicle and a series of networked gauges 115 located inside the passenger compartment of the vehicle. This system 100 allows all senders (sources of engine or vehicle data) to be connected to the sensor module 110. The sensor module 110 would then connect to the remote unit 105 and the gauges 115 through two network cables 120. These network cables 120 are also used to “daisy chain” the gauges 115 together.

The remote unit 105 may include an interface such as a universal asynchronous receiver transmitter (UART) 125, a microcontroller 130, an SD memory card interface 135, keys 140 and flash memory 145. The UART 125 is used to push bytes of information onto the bus 120 one bit at a time. As further described below, the SD memory card interface 135 is used to store vehicle or engine information on an SD memory card. The microcontroller 130 of the remote unit 105 contains software code which permits the remote unit to perform the functions indicated.

The sensor module 110 may include an interface, such as a UART 160, a microprocessor 150, an analog-to-digital converter (ADC) 155 and an analog multiplexer 165. The UART 160 is used to push bytes of information onto the bus 120 one bit at a time. The analog multiplexer 165 is used to receive all of the sender inputs 170 and to input these inputs into the ADC 155. The microcontroller 150 of the sensor module 110 contains software code which permits the sensor module to perform the functions indicated. Each of the gauges 115 includes at least an interface 180 to the bus 120 and a microcontroller 185.

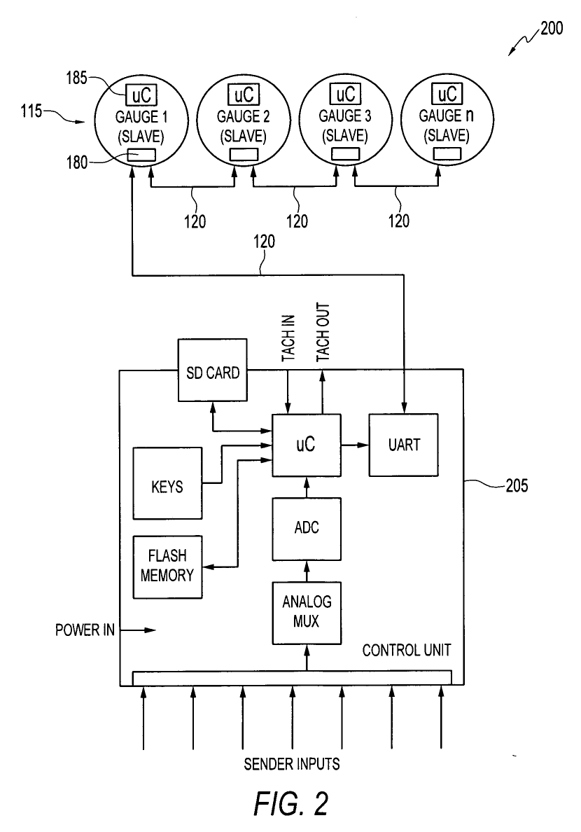

FIG. 2 illustrates another system configuration of the invention (i.e., system 200). The FIG. 2 system 200 consolidates the functionality of the remote unit 105 and the sensor module 110 from system 100 (FIG. 1) into a single control unit 205.

The system 100 or 200 utilizes serial communications. At least three serial protocols are viable. The general requirements for the serial protocol include: high immunity to electromagnetic interference, the capability of a data transfer rate high enough to accommodate 100 samples per second on each of the 9 input channels, availability of required hardware, availability of software required software libraries and overall system cost versus development cost.

The first viable protocol is a LIN low speed protocol used in combination with CAN primarily for automotive applications. LIN is inexpensive to implement, but is a low speed protocol, with a maximum data transfer rate of 20 kbps.

The second viable protocol is the CAN bus protocol. CAN bus is a very robust protocol designed for use in automotive applications. CAN is capable of delivering transfer rates up to 1 Mbps, which is more than adequate for the data transfer requirements of the invention. CAN requires two independent pieces of hardware for implementation, the CAN controller and a CAN transceiver. The CAN controller is responsible for handling low level bus operations including timing, bus arbitration, carrier detection, error generation and error detection. The CAN transceiver is a piece of hardware that converts the electrical signal from the CAN controller to a balanced, noise immune signal appropriate for use on the CAN bus. CAN by definition is a multi-master protocol; this means that any node on the bus can transmit if the bus is idle. Multi-master protocol can lead to more efficient method for relieving a predefined master from having to constantly ask the slave nodes if they have information to send.

The third viable protocol is RS-485. Like CAN, RS-485 utilizes a balanced pair protocol that is highly immune to electrical noise and also features high data transfer rates. Like CAN, RS-485 requires a bus transceiver to convert electrical signals on the bus to levels that can be used by a UART. The RS-485 protocol defines signaling levels and very low level bit timings. RS-485 does not include provisions for multi-master use. This means that during system design, one node in the system will be designated as the master and the remaining nodes will be designated as slaves. In this mode of operation slaves are not allowed to place data on the bus unless they are ask to do so by the master. The small number of nodes and relatively small amount of data traffic from the slaves to the master will not require a multi-master protocol. In a preferred embodiment, either CAN or RS-485 are used for the system network. In a preferred embodiment the remote 105 or control unit 205 would be designated as the master and the remaining nodes would be designated as slaves.

It should be noted that the systems illustrated in FIGS. 1 and 2 (as further described in the other figures) are now described with reference to specific components (e.g., processors) made by specific manufacturers. It should be appreciated that the invention is not limited to these specific components, all that is required is the functionality contained in the component and compatibility with other components within the system as is described below.

A USB port is an alternative to the SD/MMC card interface located in the remote unit 105. The addition of a USB port would provide a means to transfer data between the system and a PC. This data would include run data stored in internal memory and opening ceremony, closing ceremony and demo mode files. The USB port could be located in either the remote unit 105 of FIG. 1 or, in another embodiment of the invention, in the sensor module 110. Alternatively, the USB port could be located in the control unit 205 of FIG. 2. The Cypress CY7C68013 provides a high-speed USB port and the capability to boot from a USB connection through an external EEPROM boot sequence. If a USB system were chosen over an SD/MMC card in a preferred embodiment, the CY7C68013 would replace the Atmel ATMEGA-128 microcontroller. Alternatively, an Atmel ATMEGA-64 microcontroller could be used.

In a preferred embodiment, the system will include built-in flash memory in the remote unit 105 so that the user can record a run for playback without purchasing an SD/MMC card. Three size options could include e.g., 64 kbyte flash (approximately 35 seconds of recording), 128 kbyte flash (approximately 71 seconds of recording), and 256 kbyte flash (approximately 142 seconds of recording).

The invention preferably uses Auto Meter stepper motor gauges. The gauges 115 preferably utilize Cypress Microsystems CY8C26233 microcontrollers. These microcontrollers are ideally suited for driving a stepper motor due to their internal digital-to-analog converters and the ability to reuse the pointer positioning code that has been developed and proven reliable during years of production experience. These microcontrollers offer an internal UART, which would be a suitable hardware interface between the gauge 115 and a RS-485 system. These microcontrollers do not, however, offer a CAN controller. If CAN were selected for use in the system, an external CAN controller would be required in each gauge 115. Air core gauges may also be used with the present invention. The microcontrollers 185 of the gauge 115 contains software code which permits the gauge to perform the functions indicated.

The remote unit 105 of FIG. 1 or the control unit 205 of FIG. 2 provides most of the processing power in the respective systems 100, 200. The microcontroller 130 in the remote unit provides a hardware interface and software file system for interaction with an SD/MMC card. In addition, the microcontroller 130 in the remote unit preferably provides a means to reinstall system software via the SD/MMC card, and finally it preferably provides adequate ROM, RAM and mathematic capabilities to support the above mentioned features and the math calculations that will be required to convert the analog-to-digital converted sensor values to pointer positions. While an Atmel Atmega-128 microcontroller could be used within the remote unit, in a preferred embodiment, an Atmel ATMEGA-64 microcontroller is used. Both the ATMEGA-128 and the ATMEGA-64 are well known in the industry, offer the required SD/MMC file system libraries, provide adequate ROM and RAM resources, offer the ability to boot load from the SD/MMC card, provides a UART for communication with the network through RS-485 and provide a hardware multiplier for fast analog-to-digital converted sensor to pointer position calculations. In a preferred embodiment, equation constants used to convert raw sensor data to engineering units and pointer positions are stored in the gauges 115. Upon power-up, these constants are requested by the remote unit 105 and used by the remote unit 105 to convert raw data to pointer position. As such, any matched gauge and sender pair can consequently be used without requiring a firmware update of the remote unit 105. For example, and without limitation, a first version of the system could be shipped with a 100 psi fuel pressure gauge and sender. By storing the constants that describe the relationship between the sender output and the gauge pointer position in the gauge, any other fuel pressure gauge rants (i.e., 0-15 psi) can be added without requiring changes to the firmware located inside the remote.

Referring again to FIG. 1, the sensor module 110 microcontroller 150 provides 8-channels of 10-bit analog to digital conversion (in ADC 155), an input capture and output compare timer for tachometer signal processing and the UART 160 (although shown as a separate component) for communication with the rest of the system. These features are available on most mid-range 8-bit microcontrollers, but this application also requires an automotive temperature rating. In a preferred embodiment a ATMEGA-16 is used in the sensor module 110.

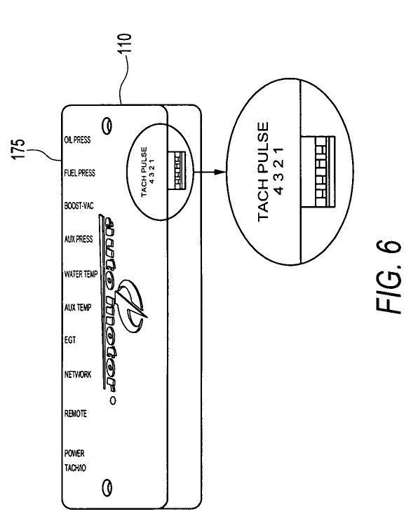

The sensor module 110 includes multiple sensor ports 175 for connections to multiple different automotive sensors (not shown); module 110 may also be referred to as a sender module because it receives all of the sender (e.g., sensor) inputs. The sensor ports 175 may include ports for Oil Pressure, Fuel Pressure, MAP (Boost-Boost/Vac-Vac), Aux Pressure (NOS, Brake, etc.), Water Temp (RTD sensor), Aux Temp (RTD sensor), Thermocouple (Type-K, EGT), Engine RPM Input and Engine RPM Output (see FIG. 6). Minimum required connections for sensor module 110 include sensor power, signal conditioning and signal broadcast electronics.

Preferably, the gauges 115 may include the following hardware and have the following specifications:
Multi-Color
6-bit color resolution (262,144 possible colors)
Utilize constant current LED drivers for best color control
Utilize Tri-color LEDs
Gauge lighting controlled together to achieve uniform lighting color
7 preset color option
   Preliminarily, red, blue, green, yellow, orange, pink, white (if LED variations allow for true white to be produced consistently)
   Automatic color scrolling is available see color section of remote operation.
Daisy Chain—digital connection between gauges & sensor module
Gauge types: Oil Pressure (0-100 psi), Fuel Pressure (1-100 psi), Boost Vac, NOS (0-1600), Water Temp (100-260), Oil Temp (100-260), EGT (0-2000 F)
Peak Recall—Clear
Warning Indicator
   User adjustable
   Change entire dial color—if dial lighting is not red, dial will change to red when warning point is reached. If dial lighting is red, dial will change to blue (or some other pre-defined color) when the warning point is reached.

Preferably, the gauges 115 will be able to perform “animations,” “simulations” or illumination of the gauges as follows: 1) Opening Ceremony (ships from factory with one opening ceremony; user upgradeable through SD card); 2) Closing Ceremony (ships from factory with one closing ceremony; user upgradeable through SD card); 3) Demo Mode (ships from factory with one demo mode; user upgradeable through SD card; where the Demo mode loops automatically); and 4) Fixed Needle Position. As used herein, “Ceremony” means a sequence of pre-programmed gauge illuminations.

The system will have playback, record, start, stop, fast forward, and rewind capabilities. The system will need some fixed internal memory, shown in FIG. 1 as Flash Memory 145, to record data if a memory card, is not present. The fixed internal memory 145 will support a minimum of 30 seconds of recording with a preferred recording time of 90 seconds. Preferably, the system will utilize small, removable memory card as primary storage device for recording and playback. Preferably, the system will accept SD or MMC cards formatted in either FAT12 or FAT16. While the fixed internal memory 145 is shown as FLASH Memory, one of ordinary skill in the art will appreciate that other types of memory may be used.

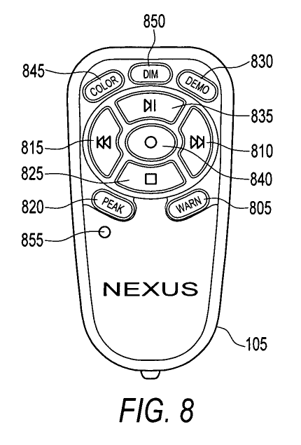

Gauges 115 will preferably include 5 brightness levels. The remote unit 105 will include a “dim” button 850 (FIG. 8). Pressing the dim button will reduce the gauge(s) brightness by at least one level. If the dim button is pressed at the lowest brightness level, the illumination of the gauge(s) will jump to the brightest level.

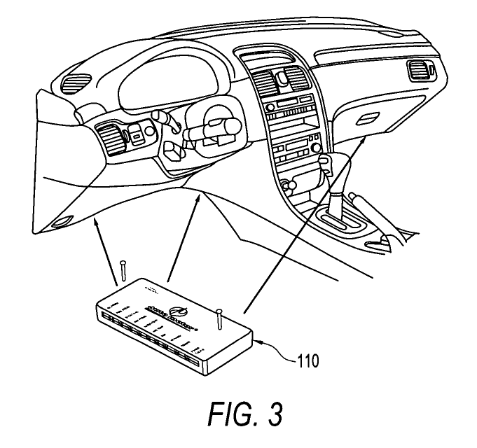

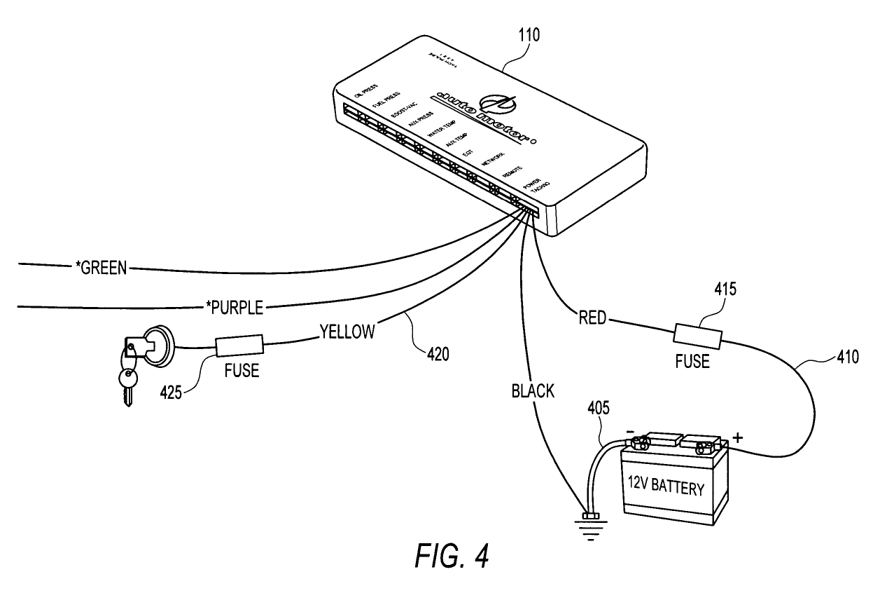

With reference to FIGS. 3 and 4, the sensor module 110 may be mounted as follows. Disconnect the negative battery cable 405 and make sure engine and exhaust have been allowed to cool before proceeding with installation. Locate a suitable location for the mounting of the sensor module 110. Recommended locations are under the dashboard, in kick panel, behind or under center console, or other suitable location. It is not desirable to mount the sensor module 110 in the engine compartment. It is also not desirable to mount the sensor module 110 or remote unit 105 in close proximity to ignition coils or ignition spark boxes as the ignition coils or ignition spark boxes may produce electrical signals that can interfere with and/or damage the system. The sensor module 110 and remote 105 may be mounted with Velcro™, screws, other type of mounting bracket.

When mounting the remote unit 105, it is desirable to check for suitable remote location and cable length to the sensor module 110. The cable may be routed as desired or necessary. To ensure proper operation, ensure the cable is not pinched and will not rub and wear through insulation resulting in system malfunction and damage to the system. Plug the remote cable into the port marked “Remote” on the sensor module 110. It is preferred to loosely coil and zip tie excess remote cable.

Referring to FIG. 4, the system may be wired as follows. Connect a first (e.g., black) wire from power harness to battery negative 405 or other good ground source such as engine, chassis, or fuse box grounds. Connect a second (e.g., red) wire 410 from power harness to constant +12 v source. It is desirable to place an automotive fuse 415 in line with this connection to protect the system hardware. Connect a third (e.g., yellow) wire 420 from power harness to switched +12 v source. Place another automotive fuse 425 in line with this connection to protect the system hardware.

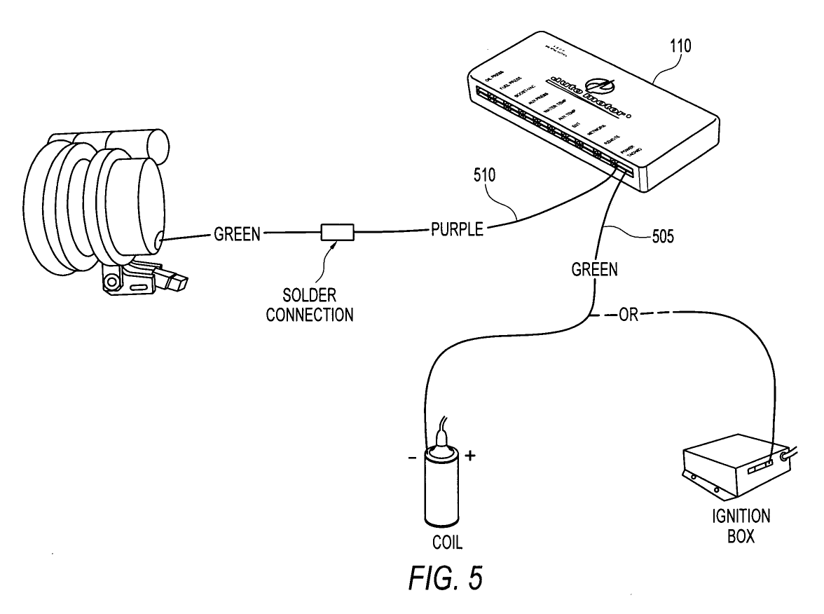

Referring to FIG. 5, the system may be furthered wired as follows should a tachometer connection be required or desired. Connect a fourth (e.g., green) wire 505 from power harness to engine RPM signal, such as computer tachometer signal or coil negative, if tachometer is also installed with the system. Connect a fifth (e.g., purple) wire 510 from the power harness to a signal input wire (green) on the tachometer. Tachometers manufactured and sold by Auto Meter are preferred. The next step is to select the cylinder setting or pulses per revolution. Flip appropriate pulse selector switches up towards the top of the case on the sensor module to activate the appropriate setting (FIG. 6). To obtain a ½ pulse for most 1 cylinder ignitions, all switches should be positioned up; to obtain 1 pulse for most 2 cylinder and twin coil 4 cylinder ignitions, the 1 pulse switch is positioned up; to obtain 2 pulse for most signal coil 4 cylinder ignitions, the 2 pulse switch is positioned up; to obtain 3 pulse for most single coil 6 cylinder ignitions, the 3 pulse switch is positioned up; and to obtain 4 pulse for most single coil 8 cylinder ignitions, the 4 pulse switch is positioned up.

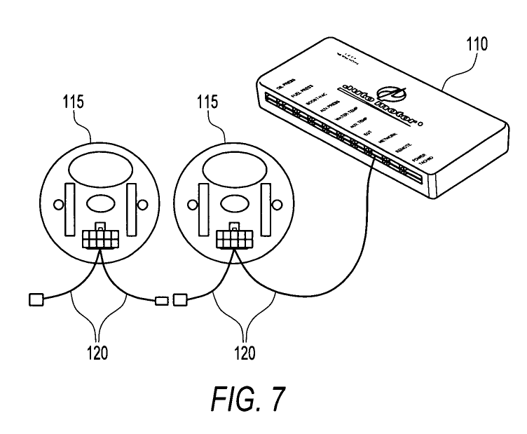

Referring to FIG. 7, the gauges may be connected as follows. Connect network cable 120 to the first gauge 115 in the series. Use additional network cables 120 to attach additional gauges 115 to the network. Connections should snap fit. The remote control 105 will cycle through the gauges 115 in the order that the sensors are listed on the sensor module 110. The system gauge network will operate with any combination of instruments, installed in any order. Preferably, additional gauges 115 may be added to the system by connecting each additional gauge 115 to an existing gauge 115 in the system or to a newly added gauge. Daisy chaining the gauges together and using the databus 120 to provide information to the additional gauges eliminates the need to hard wire additional gauges directly to the remote unit 105.

This is possible because the sensor module 110 will be wired up to operator-defined sensors (see below description). In one embodiment, the sensor module 110 has specified ports for the sensors. When the sensor module 110 receives inputs from these sensors, the sensor module 110 is capable of identifying which sensor the information was received from. The identification of the sensor is formatted in the information sent to the gauges 115. Because the gauges 115 have their own intelligence (described above), only the gauge 115 associated with the identified sensor information will accept the data from the remote unit 105 and display the data. This can be achieved by a rudimentary message format or communication protocol. The information receive by the gauges 115 maybe anything from raw sensor data to processed sensor data (e.g., gauge pointer instructions). The invention should not be limited to any particular message format or communication protocol. In a preferred embodiment the remote unit 105 sends gauge position information to the gauges 115.

The gauges 115 and sensor module 110 conduct two-way communication with the remote unit 105. The two-way communication allows the gauges 115, the sensor module 110 and the remote 105 to be able to determine whether communications have been lost. Additionally, when the sensor module 110 is turned on, an initial sequence checks communications with each of the gauges 115 and determines which of the possible gauges are present.

In one embodiment of the invention, the sensor module 110 contains ports to be connected to various sensors as is shown in the following table:

| Sensor Type | Sensor Module Port |
|---|---|
| Oil Pressure | Oil Press |
| Fuel Pressure | Fuel Press |
| Vacuum/Boost Pressure | Boost-Vac |
| Oil Temperature | Aux Temp |
| Water Temperature | Water Temp |
| Nitrous pressure | Aux Press |
| Exhaust Gas Temperature | EGT |

In this embodiment, all sensors desired to be included in the system should be connected via the harness to marked location on the sensor module 110. When all sensor harnesses are connected, the battery connections are restored and the ignition key is turned to its accessory position for activation. If the wiring is correct, gauges 115 should default to factory programmed initialization sequence.

The system will perform the following operations. When power is switched on to the system, the gauges 115 will auto calibrate, and then perform a factory programmed initialization sequence. During auto calibration the remote unit 105 determines which gauges 115 are present and data may be exchanged between the gauges 115 and the remote unit 105. Factory presets may include, pointers zero, then sweep to full scale and back to zero while changing colors and blinking the peak, warning, and record lights. When this sequence completes, the gauges 115 will default to the last selected illumination color (factory preset may be blue) and pointers will indicate current readings supplied by appropriate sensors on the network.

When the power is switched off to the vehicle, preferably the gauges will perform a factory programmed shutdown sequence. Factory presets may include sweeping the pointers to max scale and back to zero while changing colors, and then fading to black.

A demonstration operational mode is also provided. The “demo” operation causes the gauges 115 to sweep their pointers and blink lights, giving the appearance of motion and interest to the interior of the vehicle. The demo function of the system can be engaged when the power to the system is switched on. By pressing the demo button 830 on the remote, the demo function will activate, causing the gauges 115 to continuously play through the demo mode until the demo button 830 on the remote 105 is pressed again, which will end the demo operation. It should be noted that the operator will be able to create his/her own initialization, shutdown, and demo sequences.

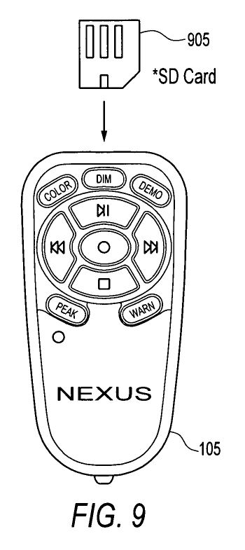

FIG. 8 illustrates the external components of the remote unit 105 which may include a removable memory card 905 as shown in FIG. 9 and can be mounted to a dash/console with Velcro™ or a bracket. The remote unit 105 includes a microcontroller 130 which contains software code which permits the remote 105 to perform the functions indicated.

The remote 105 may also include a “color” button 845. Pressing the color button 845 allows all gauges to change to the next color in the sequence. Pressing and holding the color button 845 until colors start to change to start automatic morphing of colors from one color to another. Morphing rate is predetermined at the factory. Gauges all change in unison.

The remote will include a “warn” button 805. With a press of the warn button 805, the first gauge in the series flashes and the pointer moves to the current warn point for that gauge. The Fast Forward (FF) button 810 or Rewind (Rew) button 815 may be used to change the warn set point for that gauge. Once the desired warn set point is entered for that gauge, the operator preferably presses the warn button 805 again to rotate to the warn set point for the next gauge. The warn set point for this gauge may then be adjusted using the FF 810 or Rew 815 buttons. This process continues through each individual gauge then back to first gauge again. If the warn 805, fast forward 810 or rewind 815 buttons are not pressed for a period of, preferably, 3 seconds the gauges will return to normal operation. When recording a run, the warn value will be stored in the data file header. This warn value will be used to indicate a warning condition during playback.

The remote may include a “peak” button 820. Pressing the peak button 820 causes all gauges to flash and display their peak values since the last time the peak values for the gauges has been reset. The operator can now press the stop button 825 to clear the peak for all gauges. If the peak button 820 is pressed again, the first gauge in the series flashes and the pointer moves to peak point for that gauge. The stop button 825 may be used to clear the peak reading for that gauge. Pressing the peak button 820 again increments the next gauge. Peak set points can be cleared by depressing the stop button 825, this process continues through each individual gauge then back to first gauge again. If the peak button 820 or stop button 825 are not pressed for a period of, preferably, 3 seconds the gauges will return to normal operation. Peak values will be recorded during normal operation and during record mode. Peak values will not be recorded during playback mode.

The remote unit 105 may also include a “demo” button 830. Preferably, the system will come preprogrammed from the factory with a demonstration (demo) mode and opening and closing ceremonies. If the user placed a file on the SD card with an opening ceremony file extension, this file would overwrite the existing opening ceremony in internal memory. If the user placed a file on the SD card with a closing ceremony file extension, this file would overwrite the existing closing ceremony in internal memory. If the user placed a file on the SD card with a demo mode file extension, this file would overwrite the existing demo mode in internal memory. In a preferred embodiment, a windows based program is used to allow the user to create their own demo modes and opening and closing ceremonies on a PC. In order to provide power for the closing ceremony, system power is maintained for a period of time after the system has been powered down. Preferably, a time out is include so that the system power is discontinued after a predetermined time has elapsed.

The remote unit 105 may include a “stop” button 825 to stop recording or playback; a “play” button 835 to play back recorded data at ⅓ real time rate; a “record” button 840 to begin recording a run; a “fast forward” button 810 to play back recorded data at the real time rate (can also be used to pause the playback); and a “rewind” button 815 to play back recorded data in reverse at the real time rate (can also be used to pause the playback). The play button 835 may also be used as a “pause” button to pause a playback.

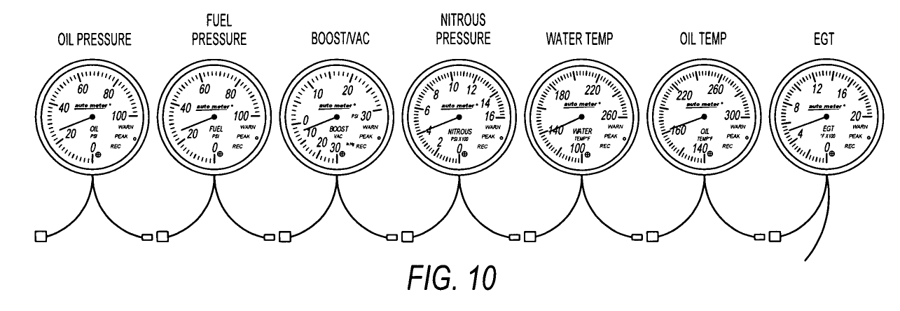

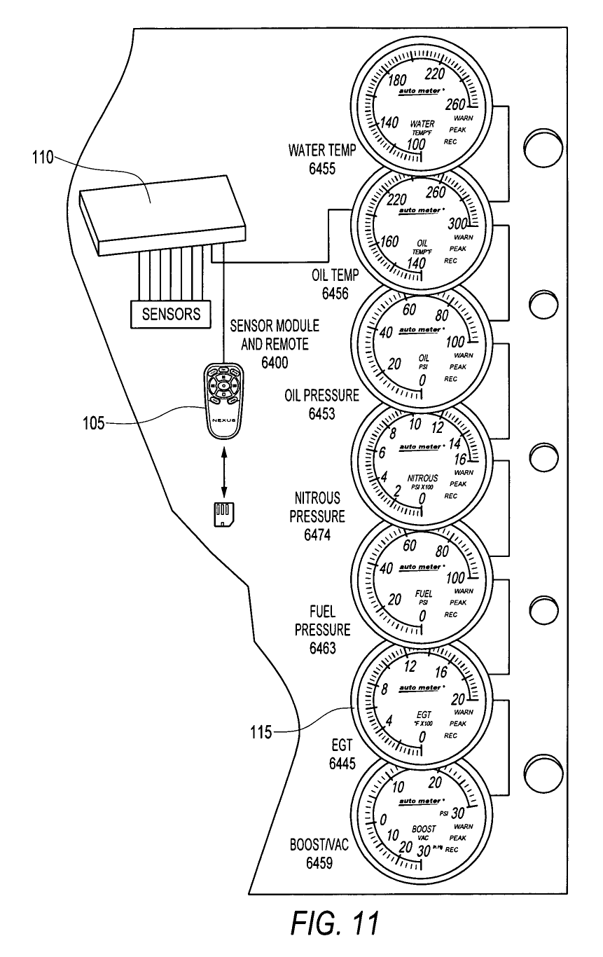

The system of the invention is able to be installed and expanded efficiently with simple modular network cables. Gauge features are operated by remote control 105 for a clean appearing dial face and optimized user control. System instruments feature the aesthetic good looks of a tinted lens and polished bezel (FIGS. 10 and 11), with the easy readability of a glowing red pointer and user-selectable high contrast LED lighting. Initialization, shutdown, demo, and color sequencing displays combine with full dial warnings, peak recall, run recording, playback, and analysis for the ultimate combination of street and performance features.

The system of the present invention includes the following illumination schemes. The system components are constantly lit while operating. By pressing the color button 845 on the remote 105 while the system is powered up, an operator can cycle through (e.g., seven) selectable illumination colors: red, white, blue, green, orange, purple, and yellow. The system features a color sequencing display option that can be engaged by pressing and holding the color button 845 on the remote for 2 seconds. Once in color sequencing mode, the lighting of the system instruments will slowly shift through the seven illumination colors until the color sequencing mode is disabled by pressing the color button 845 on the remote unit 105. In addition, hi-intensity LED illumination brightness for the system can be adjusted via the system remote unit 105, separately from the vehicle's interior dimming switch. Pressing the dim button 850 on the remote unit 105 will cycle through five levels of illumination brightness.

The system of the invention is the first instrument system to feature a full dial warning alert. When a pre-programmed set point on the gauge 115 has been reached, the gauge 115 will change to red illumination to indicate that a warning condition has been reached (if default illumination is red, then warning light color will be another color e.g., blue). To set a warn point, press the warn button 805 on the remote unit 105. In one embodiment, the warn light on the gauge 115 to be set will turn on and the pointer will move to the current warning set point. The fast forward 810 and rewind 815 buttons on the remote unit 105 may be used to adjust the pointer position to the desired warning point (oil and fuel pressure gauge warnings activate when readings reach or drop below the set point all other gauge warnings activate when readings reach or rise above the set point). To cycle to the next gauge 115 in the series, press the warn button 805 again. Repeat the above process for other gauges. Once the operator has set desired set points, after 2 seconds without a button press on the remote unit 105, the system will automatically store the new settings.

Pressing the peak button 820 on the remote unit 105 allows the operator to view peak readings for all gauges 115 on the network. All gauges 115 will have the peak light lit to indicate that they are showing peak readings (FIG. 11). Pressing the peak button again will cycle through each gauge 115 reading individually. The gauge 115 currently in peak mode will have its peak light turned on. To leave peak mode, no buttons are pressed for 2 seconds to allow the system to time out and return to normal operation. The peak reading stored can be cleared by pressing the stop button 825 while in peak mode. If the stop button 825 is pressed while displaying all peaks, then all of the peak readings will be cleared. The operator may also cycle through and clear individual peaks by displaying the peak that the operator would like to clear and pressing the stop button 825.

To record continuous data, the operator presses the record button 840 on the remote unit 105. The system will record up to e.g., 35 sec. of continuous information from all gauges 115 on the network including a tachometer for playback and analysis from the time the record button 840 is pushed. The record lights in all gauges 115 in the network will turn on to indicate recording is in process (FIG. 11). When maximum record time has been reached the record lights will shut off, indicating record mode is no longer operating. The record time may be extended by installing an SD card into the SD card slot on top of the remote (FIG. 9). In a preferred embodiment, the record lights are green.

Pressing the pay/pause button 835 on the remote unit 105 causes the system to play back the recorded information in ⅓ time. The record lights on the gauges 115 will flash and the MIL 855 on the remote will come on and stay lit green to indicate that the operator has entered playback mode. The operator may press the play/pause button 835 again to pause the gauges during playback. Use the stop button 825 to end payback and return to the beginning of the recording. Pressing and holding the fast forward 810 and rewind 815 buttons moves forward and backwards through the recording in real time. Releasing these buttons will pause the playback operation. To exit playback mode, the operator presses the stop button 825.

As noted above, the remote unit 105 may be provided with an SD memory 905 card (FIG. 9). This provides the following features. Additional recording time: up to 10 minutes per megabyte of memory space available on the card; Web updates; PC downloads; and the programming of custom initialization, shutdown, and demo sequences. The operator may program her own initialization, shutdown and demo sequences on a PC and then transfer them to the SD card, which will load them into the system for the ultimate in personalized instrumentation.

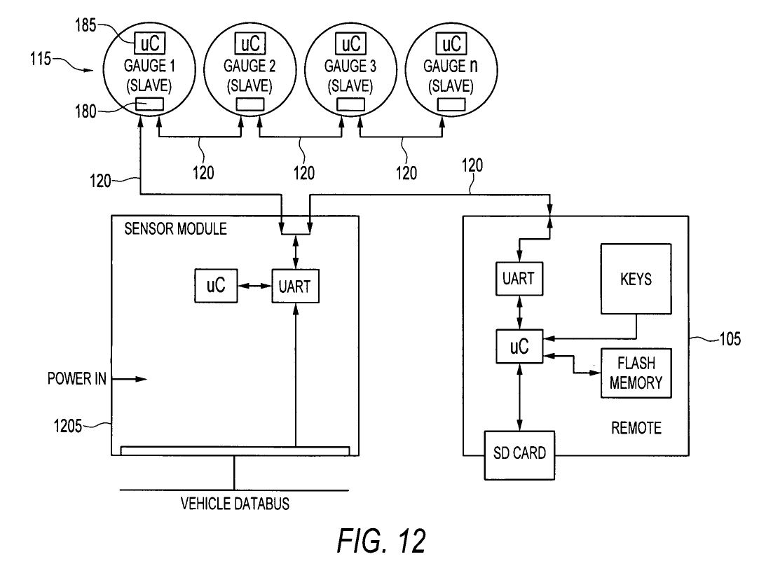

FIG. 12 illustrates a third exemplary embodiment of a system of the invention. As shown in FIG. 1, the sensor module 110 received sender inputs 170 from sensors (not shown) which monitored and measured vehicle and engine parameters. However, many vehicles today are provided with an on-board vehicle databus to communicate sensor information in digital form from the sensors on board the vehicle to one or more computers provided in the vehicle for monitoring information provided by the sensors and controlling the vehicle. When an on-board vehicle databus is available, as shown in FIG. 12, the sensor module 1205 may connect directly to the on-board vehicle databus to receive the sensor information in digital form. This sensor information can then be used as described to drive the components of the gauges 115 of the present invention.

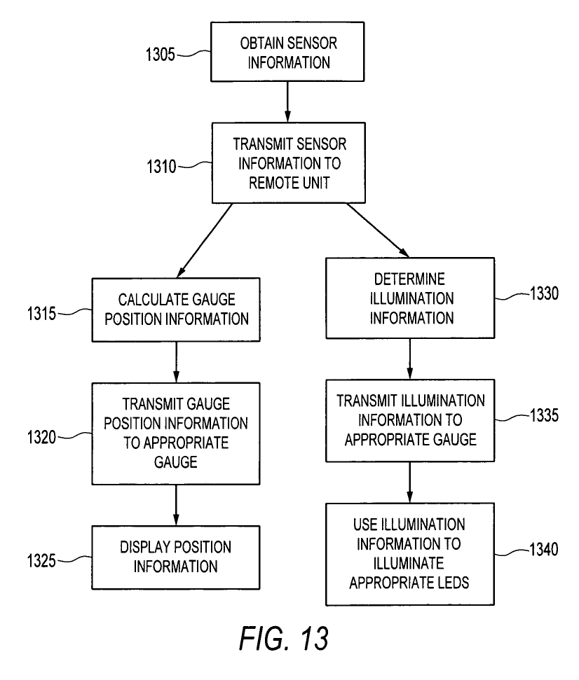

FIG. 13 is a flow chart for displaying sensor information on selected gauges. In step 1305 sensor information is obtained from the sensors or senders. In step 1310 the sensor information is transmitted to the remote unit for processing. In step 1315 the remote unit uses the sensor information to calculate the correct gauge position to accurately display the sensor information on the selected gauge. In step 1320 the gauge positional information is sent from the remote unit to the appropriate gauge. In step 1325 the gauge uses the positional information to accurately display the sensor information. Step 1325 may occur by the gauge displaying the positional information on the gauge, or in a preferred embodiment the gauge keeps track of the information currently displayed on the gauge and compares the positional information received from the remote unit to determine a change in the information currently displayed on the gauge. In the preferred embodiment the microcontroller of the gauge uses the change information to adjust the current information displayed on the gauge. In step 1330 the remote unit determines the desired illumination including warning lights, recording lights and other indications and transmits the illumination information to the appropriate gauge in step 1335. In step 1340 the gauge uses the illumination information to illuminate the appropriate lights or light emitting diodes.

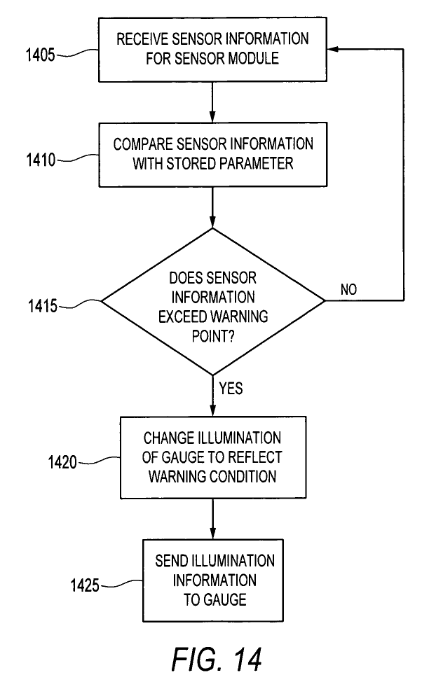

FIG. 14 shows a flow chart for adjusting the illumination of selected LEDs based on the occurrence of a warning condition. In step 1405 the remote unit receives the sensor information from the sensor module. In step 1410 the sensor information is compared to information stored within the remote unit. If, in step 1415, the sensor information indicates that the received sensor information exceeds the stored information, the remote unit illuminates the appropriate indicators. For example, if the operator has programmed the remote unit to illuminate a warning indicator when the oil temperature exceeds a certain value, the remote will compare the sensor information concerning the oil temperature and ensures the appropriate indicator is illuminated when the value is exceeded. In step 1420 the remote unit changes the illumination as a result of, for example, the warning condition and sends the new illumination information to the appropriate gauge in step 1425.

What is claimed is:

1. A modular vehicle gauge system comprising:
a remote unit, including a first microcontroller, means for changing a color of illumination of at least one gauge upon the occurrence of an event, a memory and an interface to allow communications with a sensor module and said at least one gauge;
said sensor module includes a second microcontroller, and an interface to allow communications with said remote unit and said at least one gauge;
said at least one gauge includes a third microcontroller, an interface to allow communications with said remote unit, and
means for exchanging information between said remote unit, said sensor module and said at least one gauge.

2. The modular vehicle gauge system of claim 1 wherein said sensor module is physically wired to at least one sensor and said sensor provides sensor information to said sensor module.

3. The modular vehicle gauge system of claim 2 wherein said sensor module provides said sensor information to said remote unit.

4. The modular vehicle gauge system of claim 3 wherein said remote unit provides said sensor information to said at least one gauge.

5. The modular vehicle gauge system of claim 4 wherein said remote unit converts the sensor information to pointer information and said pointer information is provided to said at least one gauge.

6. The modular vehicle gauge system of claim 4 wherein said remote unit further provides to said at least one gauge illumination information such that said illumination information is used to illuminate a light emitting diode of said at least one gauge.

7. The modular vehicle gauge system of claim 6 wherein said illumination information pertains to one of a peak light, a warning light and a record light.

8. The modular vehicle gauge system of claim 1 wherein said sensor module is connected to a vehicle data bus and said vehicle data bus provides sensor information to said sensor module.

9. The modular vehicle gauge system of claim 8 wherein said sensor module provides said sensor information to said remote unit.

10. The modular vehicle gauge system of claim 9 wherein said remote unit provides said sensor information to said at least one gauge.

11. The modular vehicle gauge system of claim 10 wherein said remote unit converts the sensor information to pointer information and said pointer information is provided to said at least one gauge.

12. The modular vehicle gauge system of claim 10 wherein said remote unit further provides to said at least one gauge illumination information such that said illumination information is used to illuminate a light emitting diode of said at least one gauge.

13. The modular vehicle gauge system of claim 12 wherein said illumination information pertains to one of a peak light, a warning light and a record light.

14. The modular vehicle gauge system of claim 1 wherein said remote unit is used to set at least one of programmable warning points, gauge illumination color selection and illumination intensity of said at least one gauge.

15. The modular vehicle gauge system of claim 1 further comprising at least two gauges wherein said gauges are daisy chained together.

16. The modular vehicle gauge system of claim 1 wherein said means for exchanging information between said remote unit, said sensor module and said at least one gauge is in conformance with RS-485 protocol.

17. The modular vehicle gauge system of claim 1 wherein said at least one gauge is configured to display at least one of an opening ceremony, a closing ceremony and a demonstration mode.

18. The modular vehicle gauge system of claim 1 wherein said at least one gauge is a stepper motor gauge.

19. The modular vehicle gauge system of claim 1 wherein the software run by the remote unit is capable of recognizing changes to the type or number of gauges in the system.

20. A method of displaying vehicle sensor information, said method including the steps of:
receiving sensor information in a sensor module;
transmitting said sensor information from said sensor module to a remote unit,
converting said sensor information into gauge positional information in said remote unit;
determining first illumination information in said remote unit;
transmitting said gauge positional information from said remote unit to a gauge,
transmitting said first illumination information from said remote unit to said gauge,
displaying said gauge positional information on a face of said gauge,
using said first illumination information from said remote unit to illuminate said gauge;
identifying the occurrence of an event,
determining updated illumination information in said remote unit based on said event;
transmitting said updated illumination information from said remote unit to said gauge; and
updating said illumination of said gauge from a first color to a second color based on said updated illumination information.

21. The method of displaying vehicle sensor information of claim 20 wherein said sensor module receives said sensor information from at least one sensor physically connected to said sensor module.

22. The method of displaying vehicle sensor information of claim 20, wherein said sensor module receives said sensor information from an on-board data bus.

23. The method of displaying vehicle sensor information of claim 20, further comprising:
determining light emitting diode illumination information in said remote unit,
transmitting said light emitting diode illumination information from said remote unit to said gauge, and
using said light emitting diode illumination information in said gauge to determine whether a light emitting diode should be illuminated.

24. The method of displaying vehicle sensor information of claim 23, wherein said light emitting diode illumination information is one of a peak light, a warn light and a record light.

25. The method of displaying vehicle sensor information of claim 20 further including displaying at least one of an opening ceremony, a closing ceremony or a demonstration mode.

26. The method of displaying vehicle sensor information of claim 20 wherein said event is programmable.

27. A computer program for displaying sensor information stored on a computer readable medium comprising:
computer program code for receiving sensor information in a sensor module;
computer program code for transmitting said sensor information from said sensor module to a remote unit,
computer program code for converting said sensor information into gauge positional information in said remote unit;
computer program code for determining illumination information in said remote unit;
computer program code for transmitting said gauge positional information from said remote unit to a gauge,
computer program code for transmitting said illumination information from said remote unit to said gauge,
computer program code for displaying said gauge positional information on a face of said gauge,
computer program code for using said illumination information from said remote unit to illuminate said gauge;
computer program code for determining updated illumination information in said remote unit;
computer program code for transmitting said updated illumination information from said remote unit to said gauge; and
computer program code for updating said illumination of said gauge from a first color to a second color based on said updated illumination information.

28. The computer program for displaying sensor information stored on a computer readable medium of claim 27 wherein said sensor module receives said sensor information from at least one sensor connected to said sensor module.

29. The computer program for displaying sensor information stored on a computer readable medium of claim 27 wherein said sensor module receives said sensor information from an on-board data bus.

30. The computer program for displaying sensor information stored on a computer readable medium of claim 27 further comprising:
computer program code for determining light emitting diode illumination information in said remote unit,
computer program code for transmitting said light emitting diode illumination information from said remote unit to said gauge, and
computer program code for using said light emitting diode illumination information in said gauge to determine whether a light emitting diode should be illuminated.

31. The computer program for displaying sensor information stored on a computer readable medium of claim 30 wherein said light emitting diode illumination information is one of a peak light, a warn light and a record light.
